(19) United States
(12) Patent Application Publication
(10) Pub. No.: US 2010/0031236 A1
(43) Pub. Date: Feb. 4, 2010

(54) System and Method to Unify Multiple Service Environments to Optimize the Delivery of Telecommunications Services

(75) Inventors: Grant F. Lenahan, Florham Park, NJ (US); Shoshana K. Loeb, Philadelphia, PA (US); David R. Gorton, Flemington, NJ (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/510,683

(22) Filed: Jul. 28, 2009

Related U.S. Application Data
(60) Provisional application No. 61/084,796, filed on Jul. 30, 2008.

(51) Int. Cl. G06F 9/44

(52) U.S. Cl. 717/120

(57) ABSTRACT

System and method to unify multiple service environments to optimize the delivery of telecommunications services include a composite service execution environment providing a common platform for executing a plurality of different execution environments. A service creation environment enables creating of service logic from a plurality of pre-defined software components and one or more inter-method communication components operable to handle communications between the plurality of different execution environments.

### CROSS-REFERENCE TO RELATED APPLICATIONS

This application claims the benefit of U.S. Provisional Application No. 61/084,796, filed on Jul. 30, 2008, which is incorporated by reference herein in its entirety.

### FIELD OF THE INVENTION

The present application relates generally to computer systems, communications and networks, and more particularly to unifying multiple service environments to optimize the delivery of telecommunications services.

### BACKGROUND

Emerging telecommunications paradigms demand accelerated service innovation, for which legacy Operation Support Systems (OSSs), Business Support Systems (BSSs) and network software are ill suited. In most cases, within the domain of real-time network execution, services require several distinct functional capabilities such as session and/or call control, service logic, and personalization by user, time, or service context as well as other factors.

Traditional solutions, most in the Intelligent Network (IN) space, were in general, fast, scalable and reliable, but lacked flexibility and required specialized programming skills which were often vendor proprietary. They also required that only experts in network signaling configure business rules such as prices, user preferences, and other business variables that impacted how a call or session would be handled by the network.

Emerging software solutions are largely based on information technology (IT) principles. These IT-like systems provide improved service innovation, greater flexibility, and greater familiarity to a wide audience of programmers and service developers. However, there are significant trade-offs that must be managed between a) flexibility, b) unintended actions (lack of quality), c) performance and d) configurability.

Flexibility measures the lack of constraints placed on developers. A flexible system can accommodate almost any service scenario. In modern systems it also generally implies a well-accepted development environment such as JAVA™ in an integrated development environment (IDE). Unintended actions are the necessary downside of flexibility. A flexible environment neither constrains the developer's innovation, nor his/her ability to make errors. It is both powerful and flexible. As a result, unintended problems or unintended service actions (results) may come of what should be straightforward service creation. Performance, scalability and cost are all various measures of the same characteristic. In real-time systems, billions of events may be processed annually. The lower the performance (in transactions per second per computer cluster) and the higher the cost of each transaction and the more complex the administration, the more scalability becomes costly and hard to achieve. Configurability measures the ease with which existing services can be modified when one parameter changes—such as a price (rating rule), trigger (user event) etc. It is desirable that these be change-able by non-technical personnel, and that the consequences of error be constrained. Otherwise, the cost of innovation —in time, money and risk—is higher.

The problem with many of the first generation “Service Delivery Platforms”, as well as most current application servers, is that they do a poor job of optimizing all of these characteristics simultaneously. One major capability of these platforms is to perform call control and/or session control. Another function is to execute service logic, which may have a significant “personalization” component. Often, the basic “Service Creation Environment” is little more than JAVA™, or Session Initiation Protocol (SIP) within an open-source IDE. In other cases, where they are being optimized for performance, the Service Creation Environment may be proprietary using low level constructs. In one case, it is highly flexible and familiar, but with poor performance and no protection against unintended consequences. In the other, performance is provided at the cost of all three of the other attributes.

Rules engines, often referred to as “policy engines”, are one popular recent approach to optimize these trade offs. Rules engines allow rapid processing of simple rules—alone or in sets. The rules may be highly flexible, but the construct lends itself to intelligent constraints—e.g.: providing a set of options such as price points (rating rules), delivery options (routing rules) or handover actions (mobility/registration rules).

While rules engines show great promise, rules (policy) engines and application servers (session control logic) typically exist as separate products. Consequently, these distributed and disparate systems require a great deal of processing and communications overhead, add to latency, and add to the complexity of any service, since it must find and access a rule on a foreign engine.

### BRIEF SUMMARY

A system and method for unifying multiple service environments to optimize the delivery of telecommunications services are provided. The system, in one aspect, may include a composite service execution environment operable to provide a common platform for executing a plurality of different execution environments. A service creation environment is operable to provide one or more tools to create a service logic using a plurality of pre-defined software components and one or more inter-method communication components that handle communications between the plurality of different execution environments. The created service logic executes in the composite service execution environment.

A method for unifying multiple service environments to optimize the delivery of telecommunications services, in one aspect, may include establishing a composite service execution environment for executing a plurality of different execution environments on a common platform. The method may also include establishing a service creation environment for creating a service logic from a plurality of pre-defined software components and one or more inter-method communication components that handle communications between the plurality of different execution environments. The service logic includes service components of different execution environments. The method may further include executing the service logic in the composite service execution environment.

A program storage device readable by a machine, tangibly embodying a program of instructions executable by the machine to perform methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an embodiment of system architecture of the present disclosure.

FIG. 2 is a flow diagram illustrating example steps taken in the present disclosure for enabling a user to develop a service logic described in the above use case scenario.

### DETAILED DESCRIPTION

A method and design that allows for better optimization of the total Service Delivery Environment across the four characteristics—flexibility, performance, configurability and reliability are disclosed. Our solution may utilize JAVA™ integrated development environment (IDE) based environments for session/call control, and rules based environments for configurability and personalization. Further our solution clearly defines the roles for rules, user data, and session control, and provides a “Service Creation Environment” across all three. Briefly, a “Service Creation Environment” is a development environment used to create the services present on the Service Control Point (SCP). An SCP contains service logic that controls services in a telecommunication system.

A “Service Creation Environment” of the present disclosure may optimize the performance of each component, as well as the inter-process communication across them. Consequently it exhibits most of the benefits of the component systems, without the costs in terms of performance, complexity and unintended actions, which are, in effect, errors. The method and system of the present disclosure may enable rich service delivery in environments where the network and service layers are separate; e,g.: IP multimedia subsystem (EMS) value chains; Mobile Virtual Network Operator (MVNOs) or any other layered business and network models.

As used herein, delivery environment means computer software or the like which allows service providers to define service logic, and executes that logic, interacting with other network and service components in real time. Ultimately, a service is delivered to end users, also referred to as consumers.

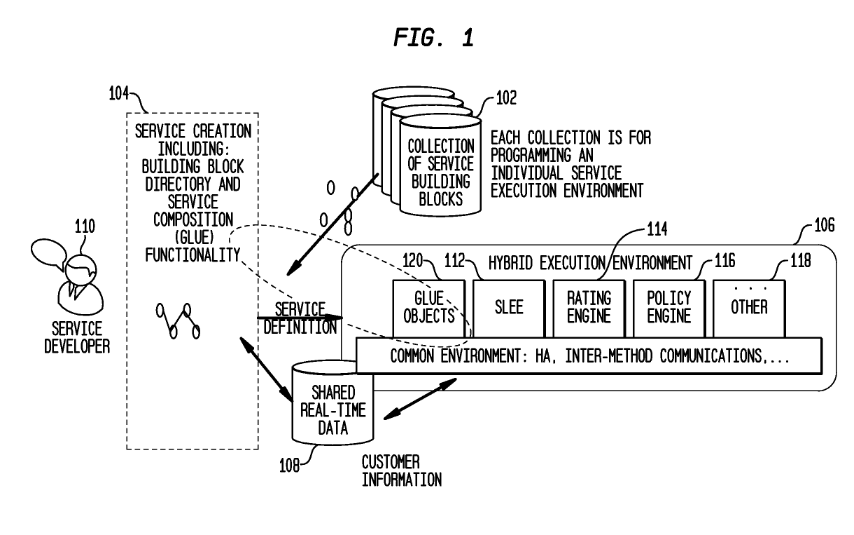

FIG. 1 illustrates functional components of the system of the present disclosure in one embodiment. A system of the present disclosure in one embodiment may include pre-defined software components 102 that serve as building blocks for new services and that may be combined by the service providers to create and deploy a service. The richness and the availability of these building blocks allow service providers to offer rich new services quickly.

Service creation environment 104 includes a user interface that allows for the discovery of available building blocks and composition of these building blocks into new services. For example, a user using the user interface may discover various building blocks that are available and compose a composite service by putting together the building blocks, for instance, in an object oriented form. The composed service may take the form of one or more rules, business policies, flow diagrams and the like. For example, a rule “only let users with account balance greater than zero buy this thing” may have a rule component, “if balance>zero, then allow”; a session control component “allow the call, session, download to proceed”; and a session intercept function, “intercept the session and hold it while evaluating the rule . . . ” The same service can use multiple such representation all stitched together in the service creation environment, and also utilizing shared real-time data 108 that may contain customer information. The composed service can span multiple execution environments in a seamless fashion. For example, the service logic which controls the telecommunication network part of the session can be running on an optimized Service Control Point, while other components of the service which describe the handling of user preferences can be executed by a policy engine and the part that handles rating and billing aspects may be executed by a specialized real time charging system. Thus, the various pieces (e.g., in object oriented form) of the composite service may run in different execution engines. All of this is invisible to the service provider and may be handled by the service creation environment 104 of the present disclosure. The Service creation module 104 presents a unified service development environment, guides the creator to the appropriate method, and for example, may identify inter-method communications, and may even insert them into the program.

The composition service execution environment 106 provides multiple execution methods within one environment and may include different execution environments such as logic that may be Java™ based and different rules and policy engines. Engines refer to software components or the like that provide ability to execute the related applications, for example, rules and policies. As shown in FIG. 1, the composition service execution environment 106 may include service logic execution environment 112, a rating engine 114, and policy engine 116. The composition service execution environment 106 may include other execution methods 118 and thus is extensible. “Glue” objects 120 handle communications between the various execution environments (e.g., 112, 114, 116, 118), including state, variable passing, and other factors.

For instance, composite service execution environment 106 includes pre-formed logic and rules that allow quick, safe and efficient development of personalized services across a subset of components, for example, a session/service control environment; a combined rules engine and account balance engine optimized for charging, tracking and usage control functions; a combined rules engine and personal data engine optimized for the creation and execution of personalized policy rules; and others.

The system enables an arbitrary range of flexible, personalized interactive service and network actions to be defined, modified and executed in a highly efficient manner. Business logic may be changed without affecting the underlying call and session control logic, reducing the likelihood of errors. Personal and context-sensitive parameters may be selected from lists of rules and actions, further limiting unintended actions. Inter-process communications are predefined to execute quickly and efficiently within a consolidated software environment.

These service execution components typically reside on a commercial off-the-shelf (COTS) hardware and operating system (OS) platform such as Linux™ or UNIX™ and rack servers or blades. These servers are typically operated by a service provider—either within the network operator's domain or connected to the network operator's domain by a pure service operator (e.g., a mobile virtual network operator (MVNO)). Often, additional middleware is present to provide high availability (HA) and operational functionality required of mission critical, high-volume operations, for example, when operations have a revenue impact—such as charging, authentication, authorization, etc.

The architecture of the present disclosure conforms to industry-standards based core network and Service Delivery Platform (SDP) architectures, and communicates with other network and SDP layer components through standardized interfaces, such as the versions of Session Initiation Protocol (SIP), Diameter, and Signaling System #7 (SS7) variants standardized by 3rd Generation Partnership Project (3GPP), 3rd Generation Partnership Project 2 (3GPP2), European Telecommunications Standards Institute (ETSI), and American National Standards Institute (ANSI). It also communicates with IT and web-based systems via Web Services (e.g.; Simple Object Access Protocol (SOAP), Extended Markup Language (XML)/hypertext transfer protocol (http)). Communication is primarily to perform session or call control, for example admission control, authorization, redirects, blocking, message insertion, tracking etc. Specific examples include the admission of a Voice over Internet Protocol (VoIP) call based on a prepaid account balance level; authorization of a Video on Demand (VoD) stream based on existing content blocking preferences (e.g., inappropriate data filtering) or insertion of an advertisement tailored to a subscriber's personal interests. Each of these requires the three logical components described above:
Session control, for example to insert a streaming advertisement;
User preferences and account information—for example, to identify the appropriate advertisement category and track usage according to plan requirements;
Configuration rules—for example, to select the correct advertisement frequency, the proper delivery method and arbitrate among various rate plans and preferences unique to that user.

The system of the present disclosure enables rich service delivery in environments where the network and service layers are separate, for example, JMS value chains; MVNOs or any other layered business and network models. The system of the present disclosure may apply to any real-time, communications platform in which two or more delivery environments, with different creation and execution methods (e.g.: Session/event control logic and policy rules) form a single, hybrid, optimized environment. Multiple service execution environments, each with its own service creation environment are combined in one environment, and both the service creation and execution are thereby optimized.

The system of the present disclosure derives from the recognition that two broad kinds of data and logic exist: relatively stable logic such as “redirect, terminate, send message”; and relatively dynamic conditions, events and actions. The system of the present disclosure imposes a separation of concerns, and assigns each to an optimized delivery environment. In this way, the frequency of changes to stable logic is reduced—and so correspondingly errors and complexity may be reduced. The separation of concerns approach of the present disclosure combines two or more delivery environments on a single software platform, with a single creation environment in a highly demanding and highly constraint computational environment. In demanding communications environments, this may allow for excellent scale, low latency and high availability, as well as reduced programmer error.

By separating relatively dynamic from relatively stable logic elements, the system and method of the present disclosure allow the creation of a deterministic set of logical objects that cover a large proportion of possible real-time network control actions. This, therefore, allows a Service Creation Environment to represent the majority of eventualities with a manageable set of code options.

In the execution environment 106, inter-process communication is accelerated (faster, better scale), because of the system and method of the present disclosure combines multiple specialized environments on a single platform where protocol overhead and context switching are minimized.

In the Service Creation Environment 104, logic guides the service creator through the process of creating an end-to-end capability, removing opportunity for errors. Application tools such as “wizards” may be utilized in this guiding process. The guided development innovation eliminates the error of logically inconsistent states, and also avoids inefficient development methodologies. Development complexity is reduced because the developer need not manage all the interactions/complexities between separate execution environments. Performance is enhanced, because the innovation utilizes shared data (reduced data lookup overhead); reduced context switching overhead; and reduced inter-process communications overhead. For instance, there is less integration between distributed and disparate systems, and easier capacity engineering and better scalability may be provided. The logic also may provide for greater independence between actions that may be configured in rules (by non-expert users) and session control actions that carry higher risks. The tight coupling of application logic with policy/rating rules avoids the complexity of feature creep in service logic by allowing personalization via policy or charging rules instead of writing additional application code.

The Service Creation Environment 104 include a set of methods—referred to as “glue”—that handle communications between the various execution environments, including state, variable passing, and other factors. Overall, the integration and optimization achieved is a result of both the Creation Environment and the corresponding “glue” objects.

A dictionary of building blocks in the Service Creation Environment 104 allows a user to identify the most appropriate building blocks. The system and method of the present disclosure may utilize an implicit service structuring and modeling approach, based on building blocks that are type-specific. In one aspect, the initial library of capabilities is derived from past heuristics. Ultimately, the service creator can follow the guide provided in the present disclosure or may over-ride it. In the present disclosure, the full capabilities of the session/network control are maintained, as opposed to existing methods, in which call/session/network control is typically abstracted to a greatly reduced level. The present disclosure provides a migration method from legacy code to the new delivery environment, by providing a structured way to separate legacy code into relatively static and dynamic components, and applying them to the appropriate delivery environment.

In the following, a user scenario is described with reference to FIG. 1. A Service creation professional 110 is writing the logic for a new service. This service allows for advertisement-subsidized mobile plans at very attractive rates. Logically, it will check a set of users and network conditions and then, in real-time, perform appropriate rating/balance management, and then, if appropriate, send the user a context-relevant advertisement. To accomplish this the service must a) suspend a data session, b) check the session context and the user's context, c) evaluate a set of personalized and context-sensitive rating rules and policies, and d) control various network elements to first send a relevant advertisement to the proper device and address, and e) restore (authorize) the original call/session.

With traditional methods, this use case requires a variety of logical methods to be invoked. Typically, a service creator would have two options:
Create session control logic, rating rules, and personal user policies from scratch, using a single general-purpose SCE/application server,
Create the constituent parts across four different platforms, including
   General purpose application server
   Specialty intelligent network (IN) or IMS session control device (e.g.: SCP, SIP Application Server)
   Rating engine or real-time charging system
   Policy engine/PDF

In the first case the service creator must use a general-purpose environment to create, from scratch, many specialized functions. This is error prone and of practical necessity limits the sophistication of the functions the creator is likely to build. In either case, it generates “spaghetti code”—one off code that is neither modular nor reused and must be maintained.

In the second case the service creator gains the advantages of four platforms that are well suited to those specialized tasks. It also has the advantage that the rating, policy and session/device control logic may be re-used in a modular fashion. But there are two significant weaknesses in this method:
1. The service creator must manage all inter-platform communication, including data transfer, logical handoffs, etc. This is a significant challenge and results in poor performance and in errors.
2. The performance cost across many boxes—with context shifts, data transfer, IP overhead, etc. is very large. Typically the performance—both throughput (and thus cost on the critical “per transaction” measure) and latency are unacceptably large for large-scale, real-time services.

In the approach provided in the present disclosure, the logical methods, for example, the four logical methods mentioned above, co-exist on a single platform and are revealed in a single creation environment. The service creator is guided through the service development—rules assigned to the rules engine; logic to the logic engine; rating functions to the rating engine and session control to session control capabilities. Session control capabilities are distinct from typical application server logic in that they employ one or several specific, real-time telecommunication protocols and typically provide tools and capabilities for common session control actions.

In the present disclosure, by providing multiple optimized execution methods and providing them on a single hardware/middleware environment, the weaknesses of other methods are overcome. For example: Optimized creation and execution environments are available, leading to quicker development, fewer errors, and more reliable, consistent code; Inter-method communications overheads are minimized; Real-time execution performance of each code function is optimized; Options can be easily constrained to those that are logical and “safe”.

Thus, for example, a service developer may use a user interface, for example, an IDE or graphical SCE at 104, and with a help of guiding elements or “wizards” that are part of that user interface, assemble a number of executable objects 102 and glue functions or objects, to create or compose a desired composite service, which is run or executed on the common environment 106.

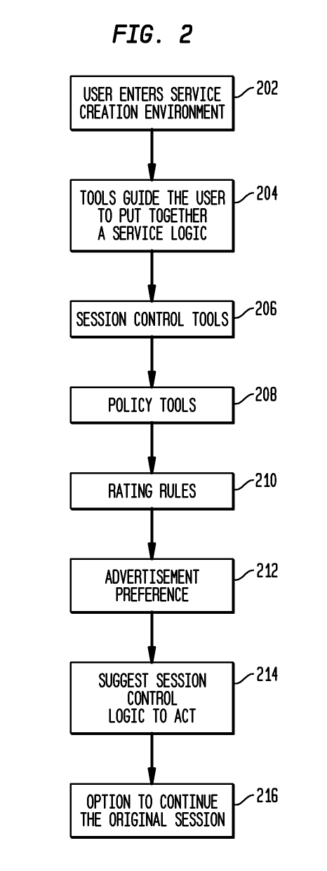

FIG. 2 is a flow diagram illustrating steps taken in the present disclosure for enabling a user (e.g., FIG. 1 at 110) to develop a service logic described in the above use case scenario. At 202, the service creator may enter the unified service creation environment of the present disclosure. At 204, tools will be available to guide his/her development logic through the process, making available, for example, in the above use case scenario, all four (or more) execution methods. As an example, an integrated development environment such as Eclipse™, graphical SCE, and/or others may be utilized. The service creator will select tools or code objects most appropriate to each step of the service logic, for instance, from a palette or menu of options and choices.

For example, first she will work with session control tools to suspend the session as shown at 206. Second, she will use policy tools to select from available context actions as shown at 208. By providing available policy context actions, the logic is constrained to feasible actions, and existing data may be automatically interrogated. Third, she will use rating rules to select from available rating actions, with similar benefits as shown at 210. Fourth, she will select from a palette of options to send advertisement preference information (for instance, advertisement category, delivery/media preferences) to an advertisement server at 212. Fifth, the Service Creation Environment will automatically suggest session control logic to act on the advertisement types returned from the advertisement server, in concert with the delivery media preferences, and send delivery data to the advertisement server and associated network elements (for example, an MMSC or streaming server which delivers a multimedia message or streaming advertisement) as shown at 214. Finally at 216, she will be presented with options to continue the original session and allow the subscriber to utilize the original service as intended. All of this will execute efficiently and with low latency—allowing for an uninterrupted user experience and huge volumes requisite in a commercial network.

As a result, the service creator gains a set of tools that are more intuitive and efficient for each aspect of the service. He/she also is guided to the proper tool. The service, once created, performs rapidly, with low latency, making it cost effective in large scale (tens of billions of events annually) networks. In addition, the code and rule elements are reusable, leading to lower maintenance and more predictable troubleshooting in the future.

As another example of a use case for the system and method of the present disclosure, a use case for migration from monolithic service application is described. A Service creation professional has an existing application for enterprise services (e.g. virtual private network offered by a network service provider) developed for a Java™ network application server. This application has implemented session management controls for routing calls between the enterprise users according to a unique dialing plan and generates call detail records (CDRs) for billing to occur by the operator (e.g. reduced price calls within the enterprise). Consider the need for enhancement of this service to meet new market/customer demands including:
Complex rating and charging features where prices now depend on time of day, day of week with spending limits for different types of calls (e.g. within enterprise, local, regional, international; from office vs. mobile)
Individual enterprise user options for incoming call management, e.g.:
   forward incoming calls to office/mobile/home or voicemail
   play personalized announcements etc. according to time of day, day of week
   or screen based on lists of telephone numbers.

In the traditional methods, this use case requires the software development professional either to develop large amounts of additional software within the application (probably several times more than the initial enterprise application) or manage complex interactions with external systems to add these features. This external interaction is likely to have severe performance and functionality impacts which not only cost the developer much time and effort in developing these new capabilities but also are likely to impact the end user experience of the service due to poor response time and inconsistent user interactions.

In the present disclosure, by supporting optimized re-usable execution methods for service logic/session control, rating and personal policy on a single hardware/middleware environment, our approach simplifies the service developer's job:
First the existing service can be migrated from its existing application server onto the application server instance in our approach.
Next, the developer adds an invocation of the real-time rating/charging component at the point in the existing service where incoming or outgoing calls are handled. Existing CDR generation software would be removed from the enterprise application as it is now done, when needed, by the charging component of our approach. The developer would need to react to the return codes from this rating/charging invocation (e.g., call might be blocked due to spending limits). A minor change to the existing service is required because our solution handles rating and charging in an rule-based environment optimized for this type of function (versus requiring these rules to be written out in code in a traditional programming language—like JAVA™—within the application) and in a way which meets the network and user performance needs because the function is seamlessly integrated within our solution in a way which is transparent to the service developer.
Similarly, the user policy engine in our approach can be used to add the new individual enterprise user features for incoming call management. The service application is updated to add an invocation of the user policy engine in its incoming call flow and react to its return status. Rules defining these controls are defined via a user policy enforcement language and the developer need not write further code in the service application as these rules change or get more complex.

As a result, an existing service application can be enhanced with powerful new charging and user customization capabilities with minor changes. This approach minimizes the growth in software complexity typically caused by “feature creep” within a telecommunication service application while retaining its level of performance because these different mechanisms are integrated in a highly efficient manner as part of a single service platform. It addition, the ongoing addition and enhancement of charging and user customization is done within specialized rule-based environments in our approach and need not be coded in traditional programming languages, thus reducing ongoing costs.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for unifying multiple service environments to optimize the delivery of telecommunications services, comprising:
a composite service execution environment operable to provide a common platform for executing a plurality of different execution environments;
a plurality of pre-defined software components operable to be combined to program a service logic;
one or more inter-method communication components operable to handle communications between the plurality of different execution environments; and
a service creation module operable to provide one or more tools to create the service logic using the plurality of pre-defined software components and the one or more inter-method communication components,
wherein the service logic includes service components of different execution environments.

2. The system of claim 1, wherein the plurality of different execution environments includes a service logic execution environment.

3. The system of claim 1, wherein the plurality of different execution environments includes an execution environment that executes rules.

4. The system of claim 1, wherein the plurality of different execution environments includes an execution environment that evaluates policies.

5. The system of claim 1, wherein the plurality of pre-defined software components include object oriented programming objects executable on a computer processor.

6. The system of claim 1, wherein the one or more inter-method communication components include object oriented programming objects executable on a computer processor.

7. The system of claim 1, wherein the one or more inter-method communication handle passing of states and variables between the plurality of different execution environments in formats native to the plurality of different execution environments.

8. The system of claim 1, wherein the service creation module includes a user interface.

9. A method of unifying multiple service environments to optimize the delivery of telecommunications services, comprising:
establishing a composite service execution environment for executing a plurality of different execution environments on a common platform;
establishing a service creation environment for creating a service logic from a plurality of pre-defined software components and one or more inter-method communication components that handle communications between the plurality of different execution environments, wherein the service logic includes service components of different execution environments; and
executing the service logic in the composite service execution environment.

10. The method of claim 9, wherein the plurality of different execution environments includes a service logic execution environment.

11. The method of claim 9, wherein the plurality of different execution environments includes an execution environment that executes rules.

12. The method of claim 9, wherein the plurality of different execution environments includes an execution environment that evaluates policies.

13. The method of claim 9, wherein the plurality of pre-defined software components include object oriented programming objects executable on a computer processor.

14. The method of claim 9, wherein the one or more inter-method communication components include object oriented programming objects executable on a computer processor.

15. The method of claim 9, wherein the one or more inter-method communication handle passing of states and variables between the plurality of different execution environments in formats native to the plurality of different execution environments.

16. A program storage device readable by a machine, tangibly embodying a program of instructions executable by the machine to perform a method of unifying multiple service environments to optimize the delivery of telecommunications services, comprising:
establishing a composite service execution environment for executing a plurality of different execution environments on a common platform;
establishing a service creation environment for creating a service logic from a plurality of pre-defined software components and one or more inter-method communication components that handle communications between the plurality of different execution environments, wherein the service logic includes service components of different execution environments; and
executing the service logic in the composite service execution environment.

17. The program storage device of claim 16, wherein the plurality of different execution environments includes a service logic execution environment.

18. The program storage device of claim 16, wherein the plurality of different execution environments includes an execution environment that executes rules.

19. The program storage device of claim 16, wherein the plurality of different execution environments includes an execution environment that evaluates policies.

20. The program storage device of claim 16, wherein the plurality of pre-defined software components and the one or more inter-method communication components include object oriented programming objects executable on a computer processor.
